(19) United States
(12) Patent Application Publication
(10) Pub. No.: US 2014/0254164 A1
(43) Pub. Date: Sep. 11, 2014

(54) IN PAVEMENT LIGHT FIXTURE WITH REMOVABLE PROTECTIVE COVER MEMBER

(71) Applicant: ADB Airfield Solutions, Columbus, OH (US)

(72) Inventors: Glenn MORROW, Westerville, OH (US); B. Russell ALEXANDER, Shrewsbury, MA (US)

(21) Appl. No.: 14/200,697

(22) Filed: Mar. 7, 2014

Related U.S. Application Data
(60) Provisional application No. 61/773,873, filed on Mar. 7, 2013.

(51) Int. Cl. F21V 17/02; F21K 99/00; E01F 9/06

(52) U.S. Cl. CPC F21V 17/02; E01F 9/065; F21K 9/30
USPC 362/277

(57) ABSTRACT

Disclosed in an example embodiment herein is an in-pavement light fixture with a removable protective cover member. The removable protective cover member is mounted on a base and protects the light source and optics. If a repair to the light source, optics, and/or light source is needed, the removable protective cover member can be removed from the base, eliminating the need to remove the in-pavement light fixture from its mounting in the pavement.

### CROSS REFERENCE TO RELATED APPLICATIONS

This application claims the benefit of priority under 35 U.S.C. §119(e) of U.S. Provisional Application No. 61/773,873 filed on Mar. 7, 2013.

### TECHNICAL FIELD

The present disclosure relates generally to in pavement light fixtures.

### BACKGROUND

In pavements lights, such as, for example, in-pavement runway lights and/or heliport deck lights, provide a more effective method for indicating critical areas on a paved surface. In-pavement lights find common use in airport runways and taxiways. Such in-pavement lights are formed below a pavements surface with the light emitting areas above the pavement surface. The area above the surface projects light outward for aircraft and vehicles. In pavement fixtures are typically used in areas where an aircraft and/or vehicle may roll over the fixture.

### BRIEF DESCRIPTION OF THE DRAWINGS

The accompanying drawings incorporated herein and forming a part of the specification illustrate the example embodiments.

FIG. 1 is a perspective view of an in-pavement light.

FIG. 2 is a top view of the in-pavement light.

FIG. 3 is a sectional view of the in-pavement light of FIG. 2 along section A-A.

FIG. 4 is sectional view of the in-pavement light of FIG. 2 along section B-B.

FIG. 5 is an exploded view of the in-pavement light.

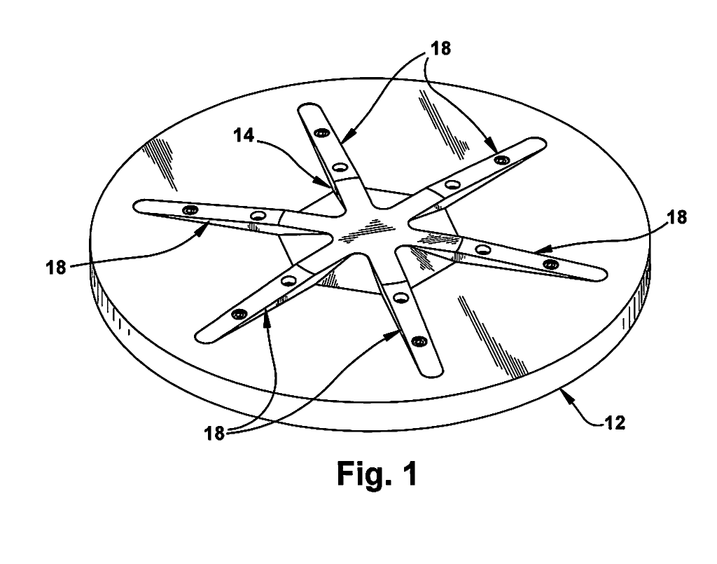

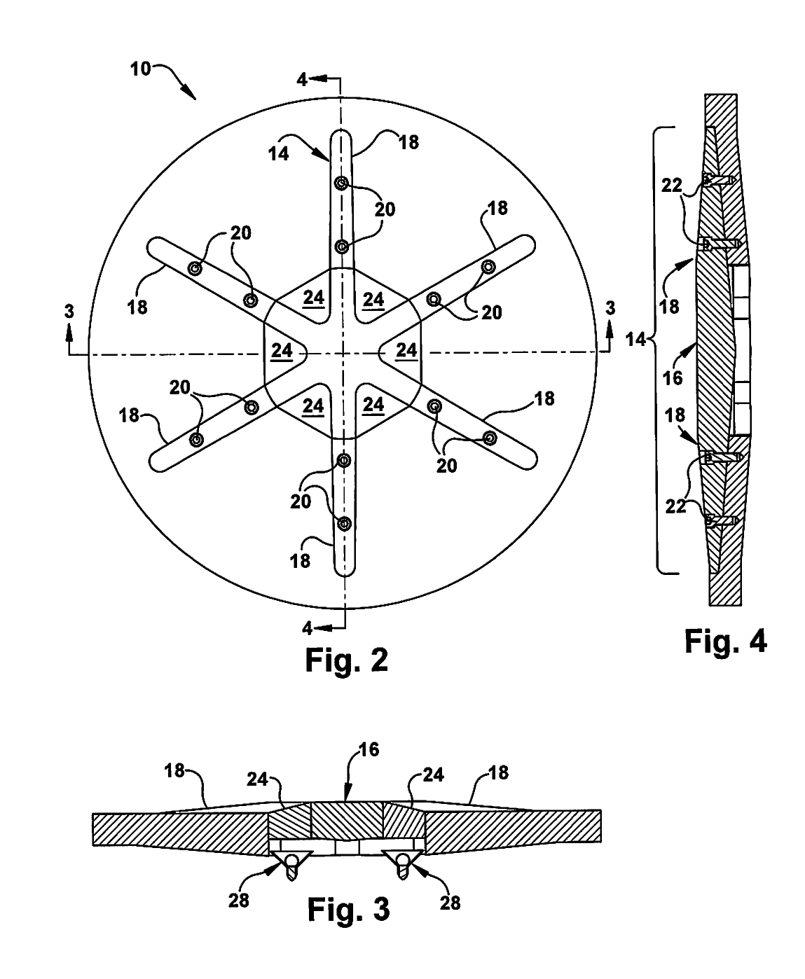

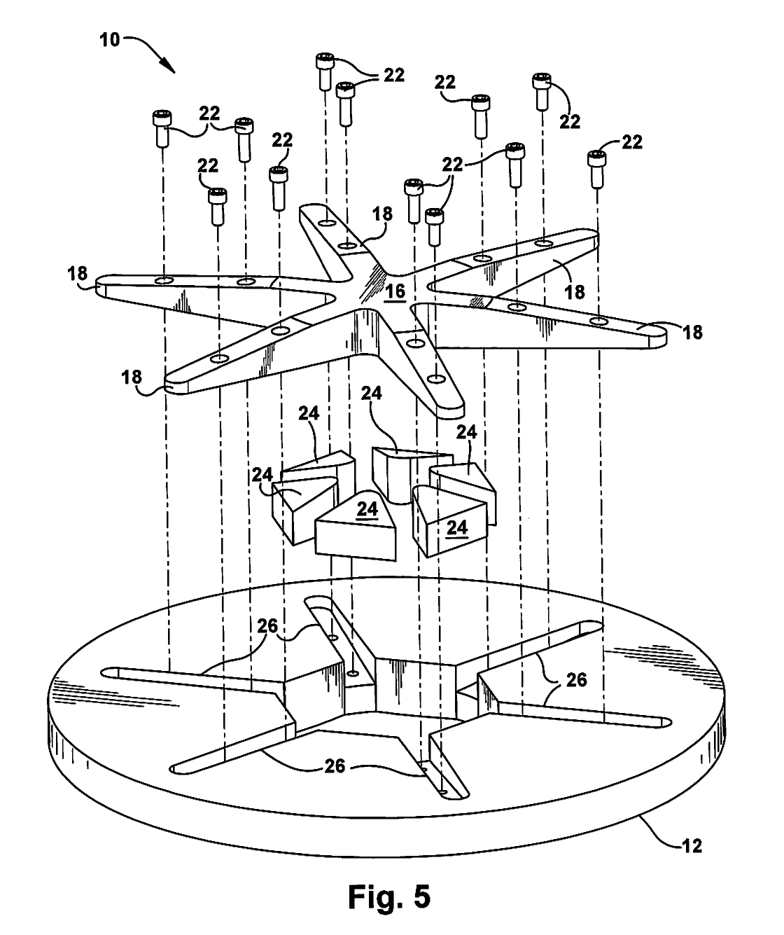

### OVERVIEW OF EXAMPLE EMBODIMENTS

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with an example embodiment, there is disclosed herein, an in-pavement light with a removable protective cover member. The removable protective cover member is mounted on a base.

### DESCRIPTION OF EXAMPLE EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

Referring to the Figures, disclosed in an example, embodiment herein is an in-pavement light fixture 10 with a protective cover member 14 mounted onto a base 12. The protective cover member 14 comprises a cover surface 16 and a plurality of radially extending arms 18 coupled with cover surface 16. Although the illustrated example shows six radially extending arms 18, those skilled in the art should readily appreciate that any physically realizable number of radially extending arms 18 may be coupled with cover surface 16. The protective cover member 14 is coupled to base 12 via a plurality of threaded fasteners 22 that are inserted through holes 20 in the radially extending arms 18. The protective cover member 14 retains optics 24 (e.g., one or more lenses to direct light in a desired pattern) onto the base 12 when mounted onto the base 12. In particular embodiments, the base 12 comprises a hollowed out portion 26 for receiving the protective cover member 14.

In an example embodiment, the in-pavement light fixture 10 comprises a light source 28 and optics 24 that are mounted under cover surface 16 to emit light in a low vertical omni-directional pattern (e.g., 1 to 8 degrees vertical). The light source 28 may be any suitable type of light source such as an incandescent light bulb, and/or a light emitting diode (LED), which may also include associated circuitry for driving the LED and/or controlling the LED's intensity. The in-pavement light fixture 10 is designed to be built into a paved surface (not shown) that is subject to snowplowing, sweeping activities and aircraft tow-bars being dragged across the in-pavement light fixture 10 which can damage the light source 28 and/or optics 24. The protective cover member 14, which protects the light source 28 and optics 24, is replaceable as a sacrificial part should it become damaged, thus removing the need to replace the whole in-pavement light fixture 10. Moreover, the protective cover member 14 can be replaced as a sacrificial part without having to remove the in-pavement light fixture 10 from its mounting in the pavement. Furthermore, removing the protective cover member 14 from the base 12 will allow access to in-pavement light fixture's 10 optical system (which comprises optics 24 and/or light source 28) without removing fixture from its pavement mounting.

In an example embodiment, the threaded fasteners 22 are screws with a hex socket. In particular embodiments, the holes 20 in the radially extending arms 18 provide for recessing of the threaded fasteners 22. This can prevent the threaded fasteners 22 from being sheared off, making their removal difficult.

Described above are example embodiments. It is, of course, not possible to describe every conceivable combination of components or methodologies for purposes of describing the example embodiments, but one of ordinary skill in the art will recognize that many further combinations and permutations of the example embodiments are possible. Accordingly, it is intended to embrace all such alterations, modifications and variations that fall within the spirit and scope of any claims filed in applications claiming priority hereto interpreted in accordance with the breadth to which they are fairly, legally and equitably entitled.

1. An apparatus, comprising:
a base configured to be mounted into a paved surface;
optics mounted on the base; and
a protective cover member that comprises a cover surface with a plurality of radially extending arms from the cover surface;
wherein the cover member retains the optics onto the base when the cover member is mounted onto the base.

2. The apparatus set forth in claim 1, wherein the base comprises a hollowed out portion for receiving the cover member.

3. The apparatus set forth in claim 2, wherein the hollowed out portion is for accepting the radially extending arms.

4. The apparatus set forth in claim 1, wherein the optics are configured to emit light in a low vertical omni-directional pattern.

5. The apparatus set forth in claim 1, further comprising a light source;
wherein the cover surface protects the light source when the cover member is mounted onto the base.

6. The apparatus set forth in claim 1, wherein the light sources comprises a light emitting diode.

7. The apparatus set forth in claim 1, wherein removing from cover member from the base allows access to the optics without removing the base from the paved surface.

8. The apparatus set forth in claim 1, further comprising a light source;
wherein removing the cover member from the base allows access to the light source without removing the base from the paved surface.

9. The apparatus set forth in claim 1, wherein the radial extended arms further comprise holes for receiving fasteners

10. The apparatus set forth in claim 9, wherein the holes are configured to allow the fasteners to be recessed into the radially extended arms.

11. An apparatus, comprising:
a base configured to be mounted into a paved surface;
a light source mounted on the base;
optics mounted on the base and operable to direct light from the light source into a pattern; and
a protective cover member that comprises a cover surface with a plurality of radially extending arms from the cover surface;
wherein the cover member retains the optics onto the base when the cover member is mounted onto the base.

12. The apparatus set forth in claim 11, wherein the base comprises a hollowed out portion for receiving the cover member.

13. The apparatus set forth in claim 12, wherein the hollowed out portion is for accepting the radially extending arms.

14. The apparatus set forth in claim 11, wherein the optics are configured to emit light from the light source in a low vertical omni-directional pattern.

15. The apparatus set forth in claim 11, wherein the cover surface protects the light source when the cover member is mounted onto the base.

16. The apparatus set forth in claim 11, wherein removing from cover member from the base allows access to the optics without removing the base from the paved surface.

17. The apparatus set forth in claim 11, wherein removing the cover member from the base allows access to the light source without removing the base from the paved surface.

18. The apparatus set forth in claim 11, wherein the radial extended arms further comprise holes for receiving fasteners

19. The apparatus set forth in claim 18, wherein the holes are configured to allow the fasteners to be recessed into the radially extended arms.
